(19) United States
(12) Patent Application Publication
(10) Pub. No.: US 2025/0259146 A1
(43) Pub. Date: Aug. 14, 2025

(54) SYSTEM AND METHOD FOR MANAGING AND RESCHEDULING EVENTS

(71) Applicant: Hooman Bahrani, Winston-Salem, NC (US)

(72) Inventor: Hooman Bahrani, Winston-Salem, NC (US)

(21) Appl. No.: 18/437,251

(22) Filed: Feb. 9, 2024

Related U.S. Application Data
(60) Provisional application No. 63/483,977, filed on Feb. 9, 2023.

(51) Int. Cl. G06Q 10/1093; G06F 3/0486

(52) U.S. Cl. CPC G06Q 10/1095; G06F 3/0486

(57) ABSTRACT

A method and a system for managing and rescheduling events is disclosed. The method comprises the steps of validating, via a processor, credentials for a user to allow signing in an account or signing up. Further, generating a set of personalized questions based on input data information entered by user. Further, creating a minute to minute timeline of the events for the user. Further, guiding the user to reach at an event location based on the minute to minute timeline. Further, rearranging between the events lined up. Further, fetching information related to at least geographical regions and the event location for the events. Further, receiving real time traffic updates based at least on the fetched information and updating the details of the event, and display and share the details of the event to the user and the guests.

### CROSS REFERENCE

This application is a non-provisional US application which claims priority to Provisional Application No. 63/483,977 filed Feb. 9, 2023, which are all hereby incorporated by reference in their entireties.

### FIELD OF THE DISCLOSURE

The invention relates to a field of event management systems in computing devices. More particularly, the invention relates to a method and system for managing and rescheduling events on a Graphical User Interface (GUI) using a computing environment.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different approaches related to methods of assembling, guiding, organizing, and managing event activities, wherein such methods themselves may also correspond to implementations of the claimed technology and invention.

Suitable planning systems allow individuals to arrange and plan future occurrences and reduce the complexity of modern life. A suitable planning system can support both ordinary and extraordinary occurrences. Some individuals maintain lists as reminders. Others mark their calendars similarly. Paper-based planning and reminder systems are susceptible to the inability to handle revisions, additions, deletions, and similar adjustments due to their set format. Planning systems primarily rely on information entered by the user or system operator and cannot take inputs from external sources or third parties. Occasionally, the second parties with whom the user may communicate may provide inputs that may be of interest to the user of the system. Typically, the user must decide on the spot whether to include these inputs or disregard these as third parties.

Many digital reminder systems cannot take inputs from third parties, such as adverts. The number and names of possible suppliers of goods and services for planned events may be restricted to those already known to the user, while more suitable vendors are disregarded.

Prior art, for various aspects contained there within, relevant to this disclosure includes U.S. Pat. Publication No US2014101248 AA to Brain Felder and David Shanley, FR. Pat. Publication No. WO21255753 A1 to Saurabh Chaudhari, and U.S. Pat. Publication No. US2011202398 AA to Sarah Photowat. In each of these prior arts, a method and/or a system to organize, manage or train events is provided. This is not an ideal solution to the problem of time management and/or change event timings whenever required.

In particular, reference '248 to Brain discloses a method and a system for gathering, organizing, distributing, and synchronizing information. The system includes at least one device comprising a processor configured to execute instructions included in an application deployed on said device, and a user interface, whereby a device user receives push information, and generates, transmits, or receives at least one real time activity feed information. A server is provided that transmits push information to at least one said device, receives said activity feed information from at least one said device, and selectively transmits said activity feed information to at least one communication media supporting selective data transfer or sharing between said one device, said server, and at least one other device configured to display at least a portion of said activity feed information. However, unlike the subject matter of the disclosed invention, Brain does not disclose or suggest guiding and assembling events based on the information received from one or more users attending the gathering or function.

Reference '753 to Saurabh discloses a method and a system for generating a plurality of suggestions for an event in a calendar in a distributed computing environment. The method includes electronically receiving a scheduling request in the calendar, a request for generating the plurality of suggestion related to the event and plurality of inputs from a user. The method includes verifying the plurality of inputs of the user from a list in a memory of a user device. The method includes identifying a category of the event based on plurality of categories of events pre-defined in a server. The method includes synchronizing the memory and the server over a network to transfer a predefined number of a subset of classified suggestions of the identified category of the event from the server to the memory.

The method includes generating the plurality of suggestions for selection by the user. However, unlike the subject matter of the disclosed invention, Saurabh does not discuss or suggest the aspect automatically rearranging events and/or changing event duration times, by receiver an information from a user or a guest attending the event.

Reference to '398 to Sarah discloses a computerized system for generating a visual presentation for visually organizing one or more planned future activities of a user. The system presents a timeline for each one of potentially several aspects of the user's life, an icon for selecting one or more timelines, and at least one advisory icon which displays advertiser content related to commercial goods or services pertaining to a future activity. The advisory icon may contain data transmitted over the internet from a web source of the vendor of the commercial good or service. The system may display recommended details of a future activity, such as a checklist of details of conducting a wedding, thereby serving as a reminder. The system may apply a filter function to eliminate some vendors from consideration due for example to excessive distance from the activity. Life aspects may include vocation, house, automobiles, children, education, pregnancy, and social occasions. However, unlike the subject matter of the disclosed invention, Sarah does not disclose or suggest the aspect of changing or rearranging timeline or scheduled time of events and/or changing event duration times, by receiver an information from a user or a guest attending the event.

Given the deficiencies of the prior art, the need remains for an effective method for assembling, guiding, managing and/or changing timelines of events and providing an end-to-end solution for sharing detailed information with the users attending the event.

### SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In one example embodiment, a system for managing and rescheduling events is disclosed. The system comprises a memory, a processor interlinked with the memory. The processor is configured to receive input data information related to events, generate a personalized set of questions for a user, based on the received data information. The processor is further configured to create a minute to minute timeline of the events for the user using an assembling module, that is viewed, shared, or downloaded by the user and guide the user to reach at an event location based on the minute to minute timeline of the events, using a guiding module. The processor is further configured to allow the user to rearrange between the events lined up by the assembling module, using a reschedule module. The system further comprises a server comprising a navigation module. The navigation module is configured to fetch information related to at least geographical regions and the event location for the events, and receive real time traffic updates based at least on the fetched information. Further, the processor is configured to generate an approximate time for each user to reach the event location using the guidance received from the guiding module and the real time traffic updates received from the navigation module.

In some embodiments, the input data information is received based at least on preset questions displayed over a user interface, wherein the input data information comprises at least user's and fiancé(e)'s name, contact details, wedding date, ceremony details, reception details, getting ready details, first look details, photography details, special first look, sunset photos.

In some embodiments, the processor is configured to collect data related to type of event, date of the event to be held, number of guests, preferred locations, parents and family information related to the user, using the assembling module. Further, the processor is enabled with an artificial intelligence (AI) module to generate the personalized set of questions for the user, based on the input data information, while creating the minute to minute timeline of the events for the user. Further, the processor is configured to synchronize the list of the events with the calendar, the current weather, type of events, and type of location, using the assembling module.

In some embodiments, the processor is configured to notify each user time to leave current location, using the guiding module, for allowing the user to reach the event location at a particular time as generated by the assembling module. In some embodiments, the processor is configured to enable the user to determine travel time between locations in case of multiple event locations, using the guiding module.

In some embodiments, the processor is configured to provide drag and drop options on the user interface, that are repositioned or re shuffled by the user to allow the user to easily rearrange the events, event locations, functions within an event among each other just by dragging and dropping, using the reschedule module. In some embodiments, based at least on rearranging of events, wherein the processor is configured to update the event details and recalculate the arrival time for the user for the event location to keep schedule accurate and prevent cross over or time conflicts between multiple events, using the assembling module and guiding module.

In some embodiments, the server further comprises a database to store details of multiple users, guest details of a particular event of a particular user, and save details of users in a contact list of the user. Further, the stored details comprise at least one of location of the users, contact details of the users, type of events to be hosted by the users, date and timing of the events to be hosted by the users, name of the guests, location of the guests, contact details of the guests, number of total members to be expected from each guests, name of the person, number of family persons, location of the person, and/or contact number.

In another example embodiment, a method for managing and rescheduling events is disclosed. The method comprises the steps validating, via a processor, credentials for a user to allow signing in an account or signing up for an account; generating, via the processor, a set of personalized questions based on input data information entered by the user on the user interface, wherein the input data information comprises at least user's and fiancé(e)'s name, contact details, wedding date, ceremony details, reception details, getting ready details, first look details, photography details, special first look, sunset photos. The method further comprises the steps of creating, via the processor, a minute to minute timeline of the events for the user using an assembling module, that is viewed, shared, or downloaded by the user; guiding, via the processor, the user to reach at an event location based on the minute to minute timeline of the events, using a guiding module; rearranging, via the processor, between the events lined up by the assembling module, using a reschedule module.

The method further comprises the steps of fetching, via the processor, information related to at least geographical regions and the event location for the events; receiving, via the processor, real time traffic updates based at least on the fetched information; and updating, via the processor, the details of the event, and sharing the updated details of the event to the user and guests.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRA WINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

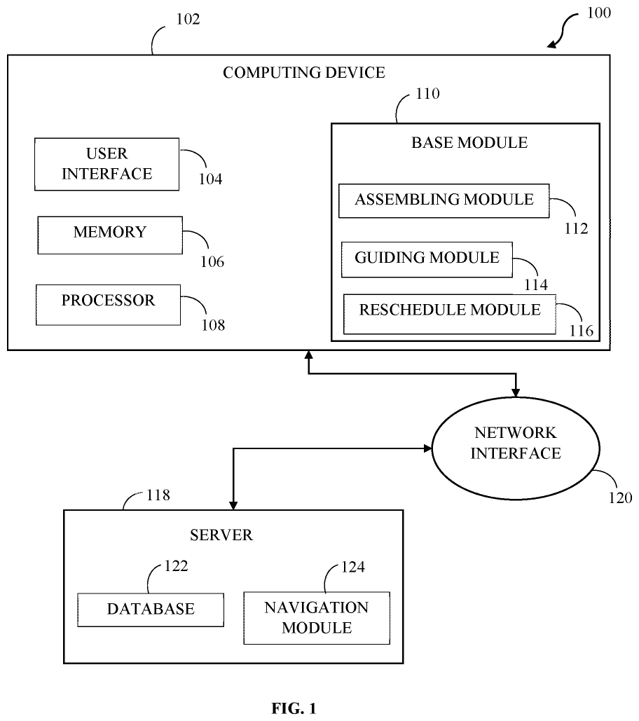

FIG. 1 illustrates a block diagram of an event management system, according to an embodiment of the present disclosure;

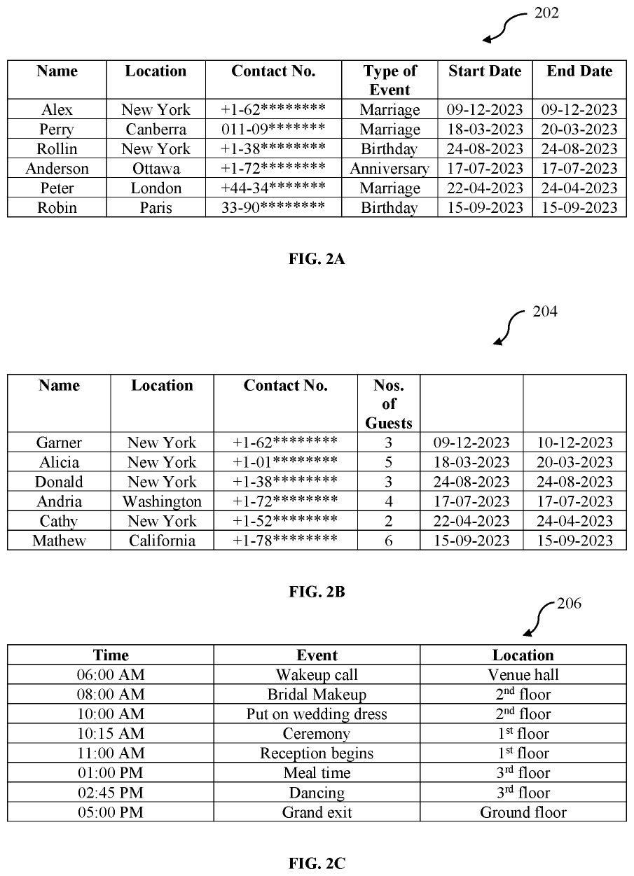

FIGS. 2A-2C illustrate table comprising user and guest data, according to an embodiment of the present disclosure;

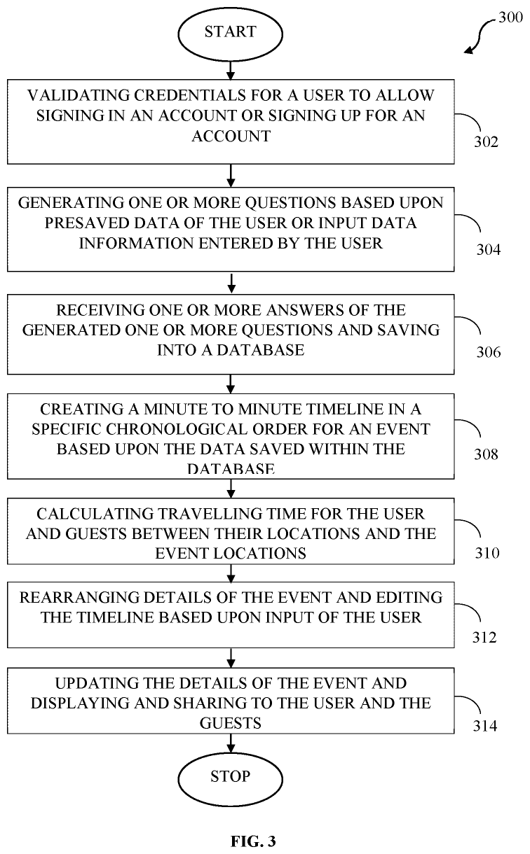

FIG. 3 illustrates a flowchart of a method for the event management for a user, according to an embodiment of the present disclosure;

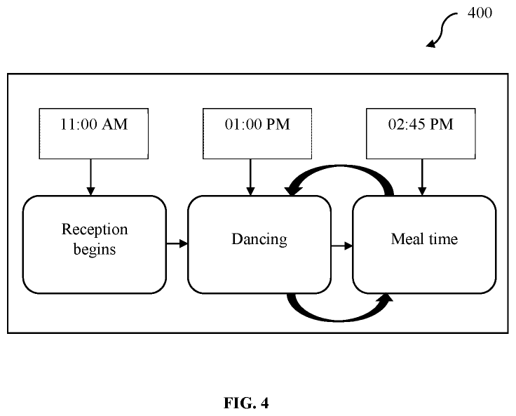

FIG. 4 illustrates a block diagram for representing reschedule module, according to an embodiment of the present disclosure; and

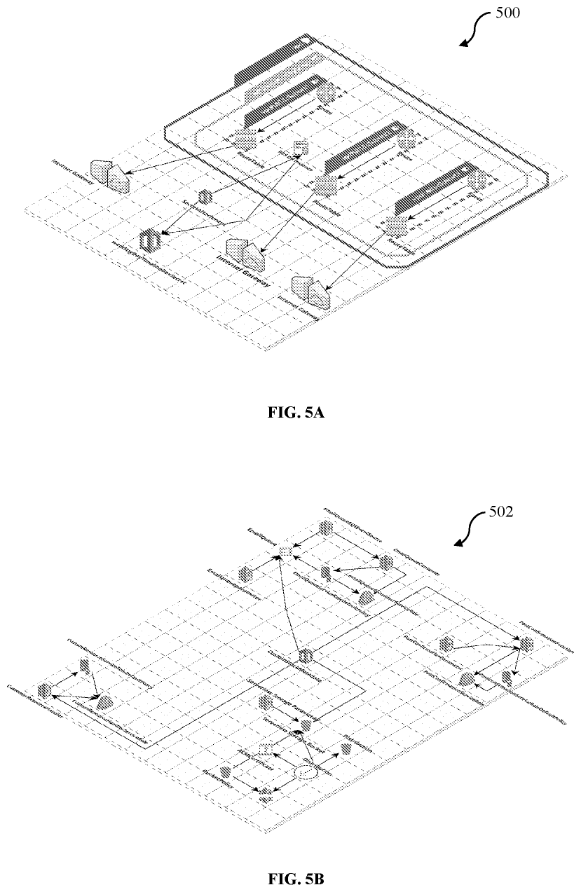

FIGS. 5A-5B illustrate working architectures of the event management system, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems, and methods are now described.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

FIG. 1 illustrates a block diagram of an event management system 100, according to an embodiment.

The event management system (100) may comprise a computing device 102 equipped by a user. Further, the computing device 102 may include a user interface 104, a memory 106, a processor 108 and a base module 110. In an embodiment, the user interface 104 may allow the user to interact with the computing device 102, in order to use its services. The user interface 104 may be configured to allow a user to input data information related to date, time, location, photo preferences etc., of an event. In an embodiment, the user may enter the input data information based upon preset questions that may be displayed over the user interface 104. The user interface 104 may include display screens, mouse, keyboard and appearance of the display screens.

Further, the user interface 104 may be interlinked with the memory 106. In an embodiment, the user interface 104 may be configured with one or more templates that may be used by the user to operate the event management system 100. The one or more templates may include “Welcome”, “The Two of You”, “Ceremony”, “Reception”, “Getting Ready”, “First Look”, “Photography”, “Special First Look”, “Sunset Photos”. The template “Welcome” may enable the user to create an account or sign in for the event management system 100. The template “Welcome” may allow the user to enter details such as Name, Address, Email-id, Location of ceremony, questions related to look preferences etc. Further, the template “The Two of You” may allow the user to enter names of both bride and/or groom, phone numbers, wedding date etc. The “Ceremony” may enable the user to enter the address of the ceremony and time. Further, “Reception” may allow the user to enter timing of each events inside the ceremony and number of guests. Further, “Getting Ready” may allow the user to enter location where the user wants to gets ready and may also show the time of travel between the location of ceremony and location where user wants to get ready.

Further, the “First Look” allows the user to conduct the ceremony where the couple gets to see each other for a first time. The template enables to select location and time of the first look. In one embodiment, if the user opts to select the first look, the user interface 104 shows related questions to the user and if the user select to not to opt for the first look, questions get changed for the user. Further, the “Photography”, the “Special First Look” and the “Sunset Photos” templates allow the user to select location and type of photos required for the ceremony. It may be noted that the questions presented over the user interface for the user may change based upon type of couple selected that is bride and bride couple, bride and groom couple or groom and groom couple.

In an embodiment, the memory 106 may be segregated as a read only memory (ROM) and a random access memory (RAM). The memory 106 may save instructions and information that may be accessed and executed by the processor 108. The information may include a preset question that may be displayed over the user interface 104 for the user. In an embodiment, the questions may be related to details of bride and groom, a wedding date, preferred locations, photo preferences and other unique day of experience questions. In one embodiment, the input data information entered by the user is temporarily saved within the memory 106.

Further, the memory 106 is interlinked with the processor 108 that is configured to execute the set of instructions saved within the memory 106 and based upon the input data information entered by the user. The processor 108 is an integrated electronic circuit to perform calculations that facilitates operation of the computing device 102. The processor 108 performs arithmetical, logical, input/output (I/O) and other basic instructions. In an embodiment, the processor 108 is linked to the base module 110. Further, the base module 110 may comprise an assembling module 112, a guiding module 114 and a reschedule module 116. It may be noted that the assembling module 112, the guiding module 114 and the reschedule module 116 may include a specific set of instructions that are executed by the processor 108 based upon the input data information given by the user.

Further, the assembling module 112 may be configured to create a minute to minute timeline of events to be managed and conducted by the user. The assembling module 112 collects the data related to type of event, date of the event to be held, number of guests, preferred locations, etc., from the memory 106 and based upon the requirement of the user, creates a timeline that involves the list of the events in a specific chronological order or alphabetical order or numeric order. In an embodiment, the assembling module 112 may synchronize the list of the events with the calendar. In an embodiment, the assembling module 112 may synchronize the list of the events with the current weather, type of events, type of location, etc.

In an embodiment, the assembling module 112 may be configured to specifically designate the minute to minute timeline of events based on the locations of the event venues and time and distance between these event venues. In an embodiment, the locations, travel time between the event venues and distance may be calculated by a navigation module 124. In one embodiment, the navigation module 124 may include, but not limited to, Global Positioning System (GPS) facilitated navigation, or Google Maps.

Further, the guiding module 114 may be configured by the user, organizers and invited members of the events to reach the event location in a convenient manner. The guiding module 114 may determine the location of the event and based upon the determined location may calculate an approximate time for each independent guest to reach the event location. In an embodiment, the guiding module 114, based upon the time taken to reach the event location, may update the minute to minute timeline of events and also notify the guests with a guiding request to leave their respective location and to reach the event location on time as generated by the assembling module 112.

In another embodiment, the guiding module 114 may also suggest best route to the guests based upon the location and traffic condition of the route. In another embodiment, the guiding module 114 may also suggest a specific gate number or a gate name of the event location that may be easily and or quickly approachable by the guest based upon his/her current location. Alternatively, the guiding module 114 may also enable the user to determine travel time between locations in case of multiple event locations.

Further, the event management system (100) may comprise a server 118 communicatively linked to the computing device 102, via a network interface 120. The server 118 may comprise a database 122 and the navigation module 124. The database 122 may be configured to store details of multiple users or hosts of the event. The data of the multiple users may include location of the users, contact details of the users, type of events to be hosted by the users and date and timing of the events to be hosted by the users.

The guiding module 114 may work in synchronization with the navigation module 124. The navigation module 124 may be configured to fetch detailed information about geographical regions and sites worldwide, may receive real time traffic updates etc. Successively, the guiding module 114 may be configured to generate an approximate time for each independent guest to reach the event location. In one embodiment, the guiding module 114 based upon the travel time calculated by the navigation module 124 for each of the guests, may update and or generate the minute to minute timeline of events for each of the guests independently.

Further, the reschedule module 116 may be configured to allow the user to change the time, date, locations, route, number of guests etc., of the event. The reschedule module 116 may provide drag and drop options that may be repositioned or re-shuffled by the user. Such drag and drop options may allow the user to easily re-arrange the events, event locations, functions within an event, among each other just by dragging and dropping. It may be noted that based upon the re-shuffling of the events, event locations, functions within the event, the processor 108 in synchronization with the assembling module 112 and guiding module 114, may update the event, date of the event to be held, number of guests, preferred locations, and also may recalculate the arrival time for the user for the event location to keep the schedule accurate and prevent cross over or time conflicts between multiple events.

As discussed, the data of the multiple users may include location of the users, contact details of the users, type of events to be hosted by the users and date and timing of the events to be hosted by the users, as shown in a table 202 represented in FIG. 2A. In an embodiment, the database 122 may also be configured to store guests' details of a particular event for a particular user. The guests' details may include name of the guests, location of the guests, contact details of the guests, number of total members to be expected from each guests etc., as shown in table 204 represented in FIG. 2B.

It may be noted that the database 122 may also save details of the guests in a contact list of the user. The details may include name of the guest, number of family persons of the guest, location of the guest, contact number, etc. Such details may allow the user organizing the event to automatically determine the number of guests that may be invited, name of the guests, their contact numbers, locations etc. In one embodiment, the assembling module 112 based upon the details may generate the minute to minute timeline of the events. Further, the database 122 may be saved with the calendar of multiple religions and languages. In an embodiment, the database 122 based upon the calendar, may be pre-saved with the festivals and important national and international events held throughout the calendar year. Based upon the data, the assembling module 112 may suggest the ideal date, time, and/or location where the event may be held.

In one embodiment, the event management system 100 may correspond to a software application on the computing device 102. In one exemplary embodiment, the software application may include, but not limited to, a mobile phone application, website, and URL. In another exemplary embodiment, the software application may be referred as an Event App. It can be noted that the Event App may be installed on a mobile phone or a computer or a laptop or a pad.

FIG. 3 illustrates a flowchart of a method 300 for the event management for the user, according to an embodiment of the present disclosure.

At first, validating credentials for a user to allow signing in an account or signing up for an account by the Event App, at step 302.

In one example, Alex enters his username as alex_murphy@eventmanagement.com and password as user_123qwerty. The processor 108 thereby cross verifies the credentials with the already saved credentials of Alex within the database 122. In case of successful matching of the credentials, the Event App displays a pop up “successfully signed” to Alex. In another case, of unsuccessful matching of the credentials, the Event App displays a pop up “unsuccessful signed” to Alex.

In another example, Peter wants to sign up for an account on the event management application. Peter enters details such as name, phone number, location and enter a new username as peter_murphy@eventmanagement.com with entering password as user_123qwerty. The processor 108 based on the credentials creates a new profile for peter.

It may be noted that the credentials entered by the user may be validated by the processor 108 by comparing with the pre-saved credentials in the database 122. Upon successful validation of the credentials, the processor 108 may thereby allow access to the user interface 104 for managing the events. In case of a new user, the user interface 104 may enable the new user to enter new details and create a new profile. The details entered by the user may thereby be saved within the database 122 for future validation of the user.

Successively, generating one or more questions based upon pre-saved data of the user or input data information entered by the user, at step 304. The input data information may be entered by the user on the user interface. Further, the data information may comprise at least user's and fiancé(e)'s name, contact details, wedding date, ceremony details, reception details, getting ready details, first look details, photography details, special first look, sunset photos.

For example, Alex is presented by series of questions by the Event App. The questions include: What is the location of the wedding ceremony? What is your role in the wedding ceremony? What is the start date and end date of the wedding ceremony? These questions may further be saved within the database 122 as shown in table 202 represented in FIG. 2A.

In one embodiment, the user interface 104 may also ask few general questions from the user including, fiancé(e)'s name, contact details, wedding date, ceremony details, reception details, getting ready details, first look details, photography details, special first look, sunset photos etc.

In an embodiment, depending upon the reception details, calculated reception time and entered reception start and end time, the user interface 104 may issue a pop-up warning of reception start time if reception is starting before the suggested start time and/or issue a pop-up warning of reception end time if reception is ending before the suggested end time. It may be noted that, the processor 108 may be enabled with an Artificial intelligence module that may allow to generate personalized set of questions from each user based upon the data including, but not limited to getting ready, first look, photography details, region, age, gender etc. saved during creating a new profile by the user. Further, the user may be enabled to enter details of the events that is to be organized by the user. The details thus entered by the user may be saved within the database 122.

Successively, receiving one or more answers of the generated one or more questions and saving into the database 122, at step 306.

For example, the Event App receives answers from Alex on: What is the location of the wedding ceremony? Ans. ABC Wedding Hall New York. What is your role in the wedding ceremony? Ans. Groom's Brother. What is the start date and end date of the wedding ceremony? Ans. Sep. 12, 2023 to Oct. 12, 2023. These answers are saved into the database 122.

Successively, creating the minute to minute timeline in the specific chronological order for the event based upon the data saved within the database 122, at step 308.

For example, the Event App generates a timeline of the wedding event based upon the details entered by Alex. The timeline includes a Time column with exact starting time of the sub events to be conducted in a day, name of the event and the location of the event. As shown in table 206 represented in FIG. 2C, the first event Wakeup call is held at sharp 06:00 AM at Venue hall. Further, the second event Bridal Makeup is held as sharp 08:00 AM at 2^{nd} floor and so on.

In an embodiment, the created timeline is available on a dashboard on the user interface 104. In an embodiment, the user interface 104 shows the timeline checklist and timeline preview on the dashboard. In an embodiment, the timeline checklist incudes, but not limited to, a pre-added checklist and a button to add new task in the checklist. In an embodiment, the pre-added checklist includes some pre-defined tasks including, but not limited to complete wedding vendors, share timeline with wedding vendors for review, share timeline with parents, bridal party and wedding vendors, etc.

In an embodiment the dashboard also includes, but not limited to, details of parents and wedding party, wedding vendors, locations of every event or function, onboarding questions, edit timeline, share my timeline, etc. In an embodiment, details of parents and wedding party includes, but not limited to, details of bride's and groom's each parent and wedding party details. In an embodiment, more parents and wedding party details can be added in the parents and wedding party details. In an embodiment, the assembling module 112 may synchronize the list of the events with the calendar. In an embodiment, the assembling module 112 may synchronize the list of the events with the current weather, type of events, type of location etc.

Successively, calculating travelling time for the user and guests between their locations and the event locations, at step 310.

For example, Garner living in New York city is notified with the best route possible and based upon the current traffic conditions, suggests to leave 1 hour prior to the event held at XYZ city that Garner wishes to attend throughout the day. Similarly, Andria living in Washington is suggested to leave 4 hours prior to the event held at QCR city.

In an embodiment, based upon the data of the guests saved within the database 122, as shown in table 204, the guiding module 114 may determine the location of the event and based upon which calculate an approximate time for each independent guest to reach the event location. In an embodiment, the guiding module 114 based upon the time taken to reach the event location, may notify each guest at what time the guest should leave their respective current location to allow to reach the event location at timeline as generated by the assembling module 112.

It may be noted that the guiding module 114 may work in synchronization with the navigation module 124. The navigation module 124 may be configured to fetch detailed information about geographical regions and sites worldwide, may receive real time traffic updates etc. Based on these information, the guiding module 114 may be configured to generate an approximate time for each independent guest to reach the event location. In one embodiment, the navigation module 124 may include, but not limited to, Global Positioning System (GPS) facilitated navigation, or Google Maps.

Successively, rearranging details of the event and editing the timeline based upon input of the user, at step 312. The details may be rearranged using drag and drop options. Further, the event clock time may be automatically adjusted in order to keep the time line accurate and without event crossover.

For example, Garner wishes to avoid massage of Alex and directly wants to visit the reception. The Event App modifies the timeline by only displaying time event of reception to Garner as 09:00 PM.

Successively, updating the details of the event and displaying and sharing to the user and the guests, at step 314.

For example, the Event App updates the finalized timeline and reflects over the account of Alex that is seen over the smartphone and also shares the updated timeline to Garner and Andria over their respective accounts that is seen by their respective smartphones.

In an embodiment the timeline may be updated by either going back to the onboarding questions or editing the timeline. In an embodiment, onboarding questions are available on the dashboard on the user interface 104. In an embodiment, the user can go back to onboarding questions to change the answers of the questions asked by the user interface 104 in order to update the timeline. In an embodiment, editing of the timeline is available on the dashboard. In an embodiment, the user interface 104 previews the timeline of including, but not limited to, groom, bride, and a combined timeline of groom and bride in editing the timeline, which can further be edited. In an embodiment, custom events can be added to the timelines including, but not limited to, lunch, dance by friends, cocktails, etc. In an embodiment, event timings will adjust according to the updating of the timeline by the user in order to keep the timeline accurate and without event crossover. In an embodiment, sharing the detailed timeline is available on the dashboard. In an embodiment, the user interface 104, lets the user to share their timeline. In an embodiment, the timeline can be shared with including, but not limited to, wedding vendors, parents and wedding party, etc. In an embodiment, the timeline is shared including, but not limited to a composed message, google map links of the event locations to any number of guests or all of the guests together. Further, the time lines may be connected to the email of the users. The user may be allowed to change the clock time, duration or name of custom events on the dashboard. Further, two events may occupy same time slot.

As discussed herein, the events may include the primary events and a custom event. In some embodiments, the primary events may be always connected to other primary events in certain sections of the timeline. Further, a user may not adjust the clock time on a primary event and only update the duration of the primary event. In some embodiments, two primary events may not occupy the same time slot. Further, in the custom events, the user may control the clock time of the event and not the duration. In some embodiments, the custom events may exist anywhere on the timeline.

In an embodiment, the reschedule module 116 may be configured to allow the user to re shuffle between the events lined up by the assembling module 112. The reschedule module 116 may provide a user friendly user interface 104 where the events along with the scheduled timeline may be displayed in an individual tab. The user may be thereby enabled to easily shift these individual tabs left or right to reschedule the events. It may be noted that, based upon the change in the schedule, the alignment module may automatically update the timeline. For example, Alex swaps between the Meal time and Dancing with each other, as shown in block diagram 400 represented in FIG. 4.

FIG. 5A-B illustrate working architectures 500, 502 of the event management system 100, according to an embodiment of the present disclosure.

FIG. 5A shows WeddingDayTimelineDecSecret that acts as a central database of the event management system 100 and is linked with a database (DB) Instance. Further, the DB Instance is an isolated database saved with user created databases. The DB Instance comprises multiple subnets that has a set of rules, that are used to determine where network traffic is directed. Further, FIG. 5B shows a custom stack metadata that is linked to a custom resource handler, an email queue, a serverless storage bucket and a post confirmation function. The custom stack metadata with the help of custom resource handler, an email queue, a serverless storage bucket and a post confirmation function, aids in managing, directing and presenting saved data to the user.

In one embodiment, the event management system 100 may facilitate the user to manage and reschedule the event via a graphical user interface (GUI) (not shown). In one embodiment, the user may correspond to a bride or a groom. The GUI may enable the user with a login page to first login the event management system 100 using his/her credentials. In case of a new user, the GUI provides an interface to sign-up using his/her credentials. Further, the GUI may guide the user to a next page to enter details in a certain sequential order as, Your Full Name, Your Fiancé or Your Fiancée Full Name, Bride or Groom, Your Email, Your Fiancé or Your Fiancée Email, Your Phone Number, Your Fiancé or Your Fiancée Phone Number, Wedding Date.

Successively, the GUI will guide the user to a next page to Select Questions and Select Timeline Event. Further, the GUI guides the user to a next page to display Ceremony. For example, the GUI will display questions as: What is the location of the wedding ceremony? Ans. ABC Wedding Hall New York. What is the start date and end date of the wedding ceremony? Ans. Sep. 12, 2023 to Oct. 12, 2023. Further, the GUI guides the user to Reception. For example, the GUI displays Tell us about your Reception with the questions as: Are you having a reception? Answer: Yes, or No: What kind of reception are you having? Answer: Lunch or Dinner: How many guests are you expecting? Answer. 100. What is the name and address of your ceremony location? Answer: Karachi Aero Club, Karachi Pakistan: Calculate Reception Time, the event management system 100, at backend will process based on the answers provided for the questions and the GUI will display as: Your reception starts at 2:00 PM and will propose more customized reception events at 4:00 PM. Moreover, the GUI will display if you have opted for a cocktail hour. It will be placed an hour before your reception start time. If the time selected by the user is earlier than recommended by the event management system 100, the GUI will display a pop-up warning, displaying Reception End Time Warning.

Further, the GUI will guide the user to a next page to Getting Ready Section, and will display questions as: what is the name and address where bride will be doing hair and makeup? Answer: address of a particular salon. Successively, the GUI will guide the user to a next page displaying, First Look with questions as: Would you like to have a first look? Answer Yes, or No. and What is the name and address of your first look location? Answer: Aero Club Karachi. The GUI may also display a first look video for the user, and may provide information about the first look. In one case, the user answers Yes to the first look, the GUI will guide the user to a next page: Photography and questions as: would you like to do a couple photos before the ceremony? Answer: Yes/No. What is the name and address where the couple photos will take place before the ceremony? Answer: location.

In another case, the user answers No to the first look, then the GUI will guide the user to a next page with questions as: would you like to do bride's bridesmaid photos before the ceremony?

Answer: Yes/No. would you like to do combined photography after the ceremony? Answer: Yes/No. what is the name and address where the combined photography will take place after the ceremony? Answer: location.

Successively, the GUI will display a Special First Look, in a next page, and will ask a few questions for the user as: would you like to have a first look? Answer: Yes/No. Would bride like to have a first look with someone special? Answer: Yes/No. Successively, the GUI will guide the user to a next page of Sunset Photos and with a question as: would you like to have sunset photos? Answer: Yes/No.

Further, the GUI will display complete your timeline event, and will guide to a dashboard. The dashboard may comprise of four sections as first section displays title or the event and time left for the event. The second section displays photograph section (couple photographs and family photos). The third section displays timeline checklist, and the fourth section displays timeline preview. The GUI may also display the bride and groom family section including the family members of the bride and groom. The use can edit the role of the family member, based on the role.

In some embodiments, the user may go through onboarding questions for free. In some example embodiments, the user may be directed to dashboard where the user can use some features for free for 7 days. Further, some features may be locked behind a paywall. After 7 days, more features may be locked behind paywall, and a few features may still be free. The user may pay via an in app sales button (not shown) to unlock all features.

In some embodiments, the user may add a timeline reset button (not shown). In some example embodiments, if the user may mess up the timeline and want to start over, the user may reset the timeline. In reset, the user may lose everything and go back through onboarding and start over. Further, the user may not be charged for resetting the timeline.

It will be apparent to one skilled in the art that the above-mentioned components of the event management system have been provided only for illustration purposes.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except in so far as indicated by the scope of the appended claims.

### LIST OF ELEMENTS

### Title: System and Method for Managing and Rescheduling Events

100 Event Management System
102 Computing Device
104 User Interface
106 Memory
108 Processor
110 Base Module
112 Assembling Module
114 Guiding Module
116 Reschedule Module
118 Server
120 Network Interface
122 Database
124 Navigation Module
202 Table
204 Table
206 Table
300 Method
302 Step
304 Step
306 Step
308 Step
310 Step
312 Step
314 Step
400 Block Diagram
500, 502 Working Architectures

What is claimed is:

1. A system for managing and rescheduling events, the system comprising:
a memory;
a processor interlinked with the memory, wherein the processor is configured to:
receive input data information related to events;
generate a personalized set of questions for a user, based on the received data information;
create a minute to minute timeline of the events for the user using an assembling module, that is viewed, shared, or downloaded by the user;
guide the user to reach at an event location based on the minute to minute timeline of the events, using a guiding module;
allow the user to rearrange between the events lined up by the assembling module, using a reschedule module;
a server comprising a navigation module, wherein the navigation module is configured to:
fetch information related to at least geographical regions and the event location for the events; and
receive real time traffic updates based at least on the fetched information,
wherein the processor is configured to generate an approximate time for each user to reach the event location using the guidance received from the guiding module and the real time traffic updates received from the navigation module.

2. The system of claim 1, wherein the input data information is received based at least on preset questions displayed over a user interface, wherein the input data information comprises at least user's and fiancé(e)'s name, contact details, wedding date, ceremony details, reception details, getting ready details, first look details, photography details, special first look, sunset photos.

3. The system of claim 1, wherein the processor is configured to collect data related to type of event, date of the event to be held, number of guests, preferred locations, parents and family information related to the user, using the assembling module.

4. The system of claim 1, wherein the processor is enabled with an artificial intelligence (AI) module to generate the personalized set of questions for the user, based on the input data information, while creating the minute to minute timeline of the events for the user.

5. The system of claim 1, wherein the processor is configured to synchronize the list of the events with the calendar, the current weather, type of events, and type of location, using the assembling module.

6. The system of claim 1, wherein the processor is configured to notify each user time to leave current location, using the guiding module, for allowing the user to reach the event location at a particular time as generated by the assembling module.

7. The system of claim 1, wherein the processor is configured to enable the user to determine travel time between locations in case of multiple event locations, using the guiding module.

8. The system of claim 2, wherein the processor is configured to provide drag and drop options on the user interface, that are repositioned or re shuffled by the user to allow the user to easily rearrange the events, event locations, functions within an event among each other just by dragging and dropping, using the reschedule module.

9. The system of claim 1, wherein based at least on rearranging of events, wherein the processor is configured to update the event details and recalculate the arrival time for the user for the event location to keep schedule accurate and prevent cross over or time conflicts between multiple events, using the assembling module and guiding module.

10. The system of claim 1, wherein the server further comprises a database to store details of multiple users, guest details of a particular event of a particular user, and save details of users in a contact list of the user.

11. The system of claim 10, wherein the stored details comprises at least one of location of the users, contact details of the users, type of events to be hosted by the users, date and timing of the events to be hosted by the users, name of the guests, location of the guests, contact details of the guests, number of total members to be expected from each guests, name of the person, number of family persons, location of the person, and/or contact number.

12. A method for managing and rescheduling events, the method comprising:
validating, via a processor, credentials of a user to allow signing in an account or signing up for an account;
generating, via the processor, a personalized set of questions based on input data information entered by the user on a user interface, wherein the input data information comprises at least user's and fiancé(e)'s name, contact details, wedding date, ceremony details, reception details, getting ready details, first look details, photography details, special first look, or sunset photos;
creating, via the processor, a minute to minute timeline of the events for the user using an assembling module, that is viewed, shared, or downloaded by the user;
guiding, via the processor, the user to reach at an event location based on the minute to minute timeline of the events, using a guiding module;
rearranging, via the processor, between the events lined up by the assembling module, using a reschedule module;
fetching, via the processor, information related to at least geographical regions and event location for the events;
receiving, via the processor, real time traffic updates based at least on the fetched information;
updating, via the processor, details of the event based one the fetched information and received real time traffic updates; and
sharing the updated details of the event to the user and guests.

13. The method of claim 12, further comprising:
collecting, via the processor, data related to type of event, date of the event to be held, number of guests, preferred locations, parents and family information related to the user, using the assembling module.

14. The method of claim 12, wherein the processor is enabled with an artificial intelligence (AI) module to generate the personalized set of questions for the user, based on the input data information, while creating the minute to minute timeline of the events for the user.

15. The method of claim 12, further comprising:
synchronizing, via the processor, the list of the events with the calendar, the current weather, type of events, and type of location, using the assembling module.

16. The method of claim 12, further comprising:
notifying, via the processor, each user time to leave current location, using the guiding module, for allowing the user to reach the event location at a particular time as generated by the assembling module.

17. The method of claim 12, further comprising:
enabling, via the processor, the user to determine travel time between locations in case of multiple event locations, using the guiding module.

18. The method of claim 12, further comprising:
providing, via the processor, drag and drop options on the user interface, that are repositioned or re shuffled by the user to allow the user to easily rearrange the events, event locations, functions within an event among each other just by dragging and dropping, using the reschedule module.

19. The method of claim 12, wherein based at least on rearranging of events, the processor is configured to update the event details and recalculate the arrival time for the user for the event location to keep schedule accurate and prevent cross over or time conflicts between multiple events, using the assembling module and guiding module.

20. The method of claim 12, wherein the server further comprises a database to store details of multiple users, guest details of a particular event of a particular user, and save details of users in a contact list of the user, wherein the stored details comprises at least one of location of the users, contact details of the users, type of events to be hosted by the users, date and timing of the events to be hosted by the users, name of the guests, location of the guests, contact details of the guests, number of total members to be expected from each guests, name of the person, number of family persons, location of the person, and/or contact number.
